(19) United States
(12) Patent Application Publication
(10) Pub. No.: US 2005/0019743 A1
(43) Pub. Date: Jan. 27, 2005

(54) Compounds and methods for improving platelet recovery and function

(75) Inventors: Denisa D. Wagner, Boston, MA (US); Wolfgang Bergmeier, Boston, MA (US)

Correspondence Address: ROPES & GRAY LLP, ONE INTERNATIONAL PLACE, BOSTON, MA, 02110-2624, US

(73) Assignee: CENTER FOR BLOOD RESEARCH, INC.

(21) Appl. No.: 10/851,255

(22) Filed: May 21, 2004

Related U.S. Application Data
(63) Continuation-in-part of application No. 10/002,585, filed on Nov. 30, 2001.
(60) Provisional application No. 60/472,516, filed on May 22, 2003.
(60) Provisional application No. 60/534,946, filed on Jan. 7, 2004.
(60) Provisional application No. 60/289,049, filed on May 3, 2001.

(51) Int. Cl. A01N 1/00

(52) U.S. Cl. 435/1.1

(57) ABSTRACT

The present invention describes an improved blood product suitable for use in transfusions comprising, in combination, blood platelets and an inhibitor of platelet glycoprotein Ibα cleavage from platelets, such as a metalloproteinase inhibitor or a TACE inhibitor. Containers for storing the improved blood product for periods of up to about 10 days, and methods for testing and using the recovered improved blood product in patient transfusions, are also provided.

### CROSS-REFERENCE TO RELATED APPLICATIONS

This application claims the benefit of priority under 35 U.S.C. 119(e) to U.S. Provisional Application No. 60/472,516, filed May 22, 2003 and U.S. Provisional Application No. 60/534,946, filed Jan. 7, 2004. This application is a continuation-in-part of co-pending U.S. application Ser. No. 10/002,585, filed Nov. 30, 2001, which claims the benefit of priority under 35 U.S.C. 119(e) to U.S. Provisional Application No. 60/289,049, filed May 3, 2001. The contents of all of the above-referenced applications are incorporated herein by reference in their entirety.

### BACKGROUND OF THE INVENTION

The present invention relates to methods for improving the post-transfusion recovery and hemostatic function of platelets upon storage as blood products. More particularly, the present invention relates to methods for improving platelet recovery and preserving the platelet hemostatic function of stored platelets by preventing cleavage of platelet glycoprotein Ibα (GPIbα) from the platelets. GPIbα is the key receptor for platelet adhesion to the subendothelium as well as to adherent platelets under arterial shear conditions.

Platelet concentrates are widely used in transfusions to support patients who receive intensive therapies for hematologic malignancies and solid tumors. Due to the danger of bacterial contamination during storage, the shelf-life of platelet concentrates is currently limited to about five (5) days. As shown by clinical studies, approximately half of the platelets remain in circulation upon transfusion into patients. Dumont et al., Transfusion 2002; 42: 847-854. Moreover, there is evidence that the hemostatic function of such platelets is markedly impaired. Valeri et al., Transfusion 2002, 42: 1206-1216. Various methods for inactivating contaminating bacteria and for monitoring bacterial growth in platelet concentrates are currently under development as described in Blood, 2003, 101, pages 2426-2433.

Platelet concentrates undergo a number of events during collection, processing and storage that adversely affect platelet structure and function, resulting in a reduced post-transfusion recovery of cells in vivo. The observed changes are termed “platelet storage lesion” (“PSL”), and include the rearrangement of the platelet cytoskeleton, microvesiculation, translocation of phosphatidyl serine to the outer leaflet of the plasma membrane, and changes in the surface expression of various adhesive platelet glycoproteins, including CD62P (P-selectin) and CD42b (GPIbα). Platelet storage lesion occurs during processing and storage subsequent to mechanical trauma, hypoxic conditions or exposure to cold.

Microvesiculation and phosphatidyl serine exposure are also hallmark characteristics of apoptosis, a physiological program for the safe elimination of dying cells by phagocytes. In most pathways leading to apoptosis, permeabilization of the inner and outer mitochondrial membranes is critical, resulting in the uncoupling of the respiratory chain with the collapse of the electrochemical gradient Δψm. This potential is essential for various cellular functions, including the production of ATP via oxidative phosphorylation.

It is currently unclear if platelets, as enucleated cells, have retained the memory of the “parental” megakaryocytes for apoptosis. However, there is a growing body of evidence supporting this idea. A recent study describes a complete apoptotic program for human platelets cultured for up to 24 hours at 37° C. in the presence and absence of plasma, conditions that closely resemble those obtained in platelet concentrates. Apoptosis leads to cytoplasmic condensation, retention of plasma membrane integrity, cell surface exposure of phosphatidyl serine and P-selectin, and clearance of intact effete platelets by phagocytes. Apoptosis under such experimental conditions seems to be capsase-independent, as it was not affected by capsase inhibitors, nor was there evidence for capsase-3 activation, suggesting that mitochondrial injury might be involved.

Proteolytic cleavage has been identified as a key mechanism for the downregulation of a variety of adhesion receptors expressed on the platelet surface, including P-selectin, CD40 ligand, PECAM, and the GPV and GPIbα subunits of von Willebrand factor receptor complex, GPIb-V-IX. The identity of the particular protease mediating the release of these receptors, however, is not known.

The GPIb-V-IX complex plays an important role for the adhesion of circulating platelets to sites of vascular injury. Cellular activation results in the translocation of GPIb-V-IX complexes from the cell surface into intracellular compartments, as well as in ectodomain shedding of the GPIbα subunit on the cell surface. Furthermore, the release of soluble GPIbα (glycocalicin) has been observed under conditions of extended platelet storage such as found in platelet concentrates.

It will be readily appreciated by those skilled in the art that there exists a need to improve the storage shelf-life and recovery of human blood platelets. Accordingly, it is an objective of the present invention to improve the post-transfusion recovery of platelets in a manner that preserves the hemostatic function of the platelets. It is a further objective of the present invention to prevent the cleavage of platelet glycoprotein GPIbα from platelets during storage, thereby preserving the hemostatic function of the platelets.

### SUMMARY OF THE INVENTION

In one embodiment, the present invention relates to an improved blood product for use in transfusions in circumstances where blood is needed as a part of the medical treatment of a subject. In one aspect of this embodiment, the improved blood product is prepared by incorporating an inhibitor of GPIbα shedding, and preferably a metalloproteinase inhibitor, in a platelet preparation, and preferably a platelet storage container for the blood product, in an amount effective to prevent the cleavage of platelet glycoprotein (GP) Ibα from the platelets. In another aspect of this embodiment, the improved blood product is prepared by incorporating an inhibitor of tumor necrosis factor-α converting enzyme (or “TACE”) in a platelet preparation in order to prevent cleavage or shedding of platelet glycoprotein (GP)Ibα from the platelets while maintained in a suitable storage container. The improvements resulting from this embodiment of the invention include enhanced platelet recovery, and the preservation of platelet hemostatic function of the stored platelets. In addition to the inhibitor described herein, the improved blood product can also contain an agent effective to block platelet aggregation.

In another embodiment, the present invention relates to a process for storing a blood product containing platelets. In one aspect, the stored blood product can contain an inhibitor of GPIbα shedding, preferably a metalloproteinase inhibitor. In another aspect, the stored platelets can contain an inhibitor for TACE. The treated platelets are stored in a suitable storage container for a time period of from about 3 to about 10 days, and preferably for about 5 days, prior to use in a transfusion. The recovery of platelets is improved following storage, and the hemostatic function of the platelets is preserved, as compared to untreated platelets.

In a further embodiment, the present invention relates to a method for treating a patient by administering to the patient the improved blood product prepared according to this invention.

In a still further embodiment, the invention relates to a container for storing the improved blood product of this invention. Preferably, the container is a blood collection bag or a platelet storage container of the type used in a blood bank.

In a yet further embodiment, the invention relates to a method for testing the quality of stored platelets by determining the level of expression of GPIbα on the platelet surface, with a low level of GPIbα indicating inferior quality and inferior biological competence of the stored platelets. Preferably, this is accomplished in the blood bank prior to the infusion of the platelet concentrate in the patient.

In a yet further embodiment, the invention broadly relates to the remediation and treatment of pathologies in which TACE produces a thrombocytopenia by cleaving cell surface markers other than TNFα by the appropriate use of suitable TACE inhibitors.

### BRIEF DESCRIPTION OF THE DRAWINGS

FIG. 1 is a series of graphs of carbonyl cyanide m-chlorophenylhydrazone (CCCP) treatment of mouse platelets.

FIGS. 2A-2D are pictoral and graphical representations of CCCP-treated mouse platelets resembling platelet storage lesion.

FIGS. 3A and 3B are graphs showing the storage of mouse platelets.

FIGS. 4A-4D are graphs showing the inhibition of metalloproteinase activity in CCCP-treated mouse platelets.

FIGS. 5A and 5B are graphs showing the inhibition of metalloproteinase activity in stored mouse platelets.

FIGS. 6A and 6B are graphs showing the improved hemostatic function of mouse platelets damaged in the presence of a metalloproteinase inhibitor.

FIG. 7 is a series of graphs showing that the shedding of GPIbα expressed on the mouse platelet surface is TACE-dependent (as determined by flow cytometry).

FIG. 8 is a photomicrograph showing the detection of glycocalicin (soluble GPIbα) in the supernatant of CCCP-treated mouse platelets.

FIG. 9 is a graph showing the improved post-transfusion recovery of damaged TACE-deficient mouse platelets when compared to wild-type mouse platelets.

### DETAILED DESCRIPTION OF THE INVENTION

The present invention concerns improved blood platelet compositions, and methods for preparing, storing, quality testing and using such compositions. These improvements can be achieved by the inhibition of platelet-derived metalloproteinases during platelet storage. Alternatively, these improvements can also be achieved by the inhibition of tumor necrosis factor-α converting enzyme (also designated as “TACE” or “ADAM 17”) during platelet storage and results in improved post-transfusion recovery of platelets, the blocking of GPIbα shedding, and improved platelet adhesive function under physiologic flow conditions. This results in improved post-transfusion recovery of platelets, the blocking of GPIbα shedding, and improved platelet adhesive function under physiologic flow conditions.

As used herein, the term “inhibitor” includes both metalloproteinase inhibitors and TACE inhibitors, is not restricted to any mode or mechanism of action, and includes antagonists, analogs and mimetics.

A “metalloproteinase inhibitor” includes any compound which modulates or inhibits the cleavage of platelet glycoprotein Ibα (GPIbα) from the platelets, and facilitates the recovery of platelets following storage. Examples of metalloproteinase inhibitors include Galardin, N-[(2R)-2-(Hydroxamidocarbonylmethyl)-4-methylpentanoyl]-L-tryptophan methylamide), GM6001, available from Calbiochem, La Jolla, Calif.; doxycycline, α-6-Deoxy-5-hydroxytetracycline; and SB-3CT(MMP-2/MMP-9 inhibitor VI), all commercially available from Calbiochem. Other macromolecular metalloproteases that can be purified from tissue or can be made as recombinant proteins include TIMP (tissue inhibitors of metalloproteases), commercially available from Calbiochem such as TIMP-1, TIMP-2, TIMP-3 or TIMP-4. Further examples of metalloproteinase inhibitors include (3S)-(−)-[2-(4-Methoxybenzenesulfonyl)-1,2,3,4-tetrahydroisoquinoline-3-hydroxamate], N-Isobutyl-N-(4-methoxyphenylsulfonyl)-gly-cylhydroxamic Acid, N-Hydroxy-1-(4-methoxyphenyl)sulfonyl-4-benzyloxycarbo-nylpiperazine-2-carboxamide, N-Hydroxy-1-(4-methoxyphenyl)sulfonyl-4-(4-bi-phenylcarbonyl)piperazine-2-carboxamide, N-Hydroxy-1,3-di-(4-methoxybenzen-esulphonyl)-5,5-dimethyl-[1,3]-piperazine-2-carboxamide, N-[(2R)-2-(Hydroxamidocarbonylmethyl)-4-methylpentanoyl]-L-tryptophan Methylamide, N-[[(4,5-Dihydro-5-thioxo-1,3,4-thiadiazol-2-yl) amino]carbonyl]-L-phenylalanine Methyl Ester, N-[[(4,5-Dihydro-5-thioxo-1-,3,4-thiadiazol-2-yl)amino]carbonyl]-L-phenylalanine, (2R)-[(4-Biphenylylsulfonyl)amino]-N-hydroxy-3-phenylpropionamide, (3R)-(+)-[2-(4-Methoxybenzenesulfonyl)-1,2,3,4-tetrahydroisoquinoline-3-hydroxamate], α-[[[(4,5-Dihydro-5-thioxo-1,3,4-thiadiazol-2-yl)amino]-carbonyl]amino]-N-(cyclohexylmethyl)-(S)-benzenepropanamide, alpha.-[[[4,5-Dihydro-5-thioxo-1,3,4-thiadiazol-2-yl) amino]carbonyl]amin-o]-((2-pyridyl)piperazinyl)-(S)-benzenepropanamide, α-6-Deoxy-5-hydroxytetracycline, 7-Aza-2-phenylbenzisothizol-3-one, 7-Dimethylamino-6-demethyl-6-deoxytetracycline, HCl, (2R)-2-[(4-Biphenylylsulfonyl)amino]-3-phenylpropionic Acid, N-t-Butoxycarbonyl-L-leucyl-L-tryptophan Methylamide, N-[(2R)-2-(Carboxymethyl)-4-methylpentanoyl]-L-tryptophan-(S)-methyl-benzylamide, Chlorhexidine, Dihydrochloride, 1,6-bis[N′-(p-Chlorophenyl)-N5-5-biguanido]hexane, 2HCl, CHX, CL-82198, XG076, Vibramycin, HCl, (+)-(3R′,5S′,6E)-7-[3-(4-Fluorophenyl)-1-isopropylindol-2-yl]-3,5-dihydro-xy-6-heptenoate, Doxycycline, Hydrochloride, Fluvastatin, FN-439, GM1489, GM6001, MMP Inhibitor I, MMP Inhibitor II, MMP Inhibitor III, MMP Inhibitor IV, MMP Inhibitor Set I, MMP-2 Inhibitor I, MMP-2/MMP-3 Inhibitor I, MMP-2/MMP-3 Inhibitor II, MMP-2/MMP-3 Inhibitor III, MMP-2/MMP-3 Inhibitor IV, MMP-3 Inhibitor I, MMP-3 Inhibitor II, MMP-3 Inhibitor III, MMP-3 Inhibitor IV, MMP-3 Inhibitor V, MMP-3 Inhibitor VI, MMP-8 Inhibitor I, MMP-9/MMP-13 Inhibitor I, MMP-9/MMP-13 Inhibitor II, NNGH, OA-Hy, cis-9-Octadecanoyl-N-hydroxylamide, Oleolyl-N-hydroxylamide, Ac-RCGVPD-NH2, SB-3CT, stromelysin-1 Inhibitor, Vibramycin HCl, XG076, CL-82198 and HONH-COCH2CH2-FA-NH2. Preferred metalloproteinase inhibitors include TAPI-1, Galardin or doxycycline, more preferably, TAPI-1 or Galardin. For macromolecular metalloproteases, preferred inhibitors include TIMPs, more preferably, TIMP-1, TIMP-2, TIMP-3 or TIMP-4, most preferably, TIMP-2.

A TACE inhibitor is any substance which inhibits the activity of tumor necrosis factor-α converting enzyme. TACE is a member of the ADAM disintegrin and metalloproteinase family of proteins, and it can be characterized as mediating the shedding of GPIbα from the surface of mouse platelets. TACE can also mediate the release of a variety of other cell surface transmembrane proteins, including growth factors, cytokines, and adhesion molecules. The inactivation of the metalloproteinase activity of TACE by the targeted deletion of the Zn²⁺ binding domain results in perinatal lethality in mice, demonstrating the significance of ectodomain shedding in vivo. Examples of TACE inhibitors include (E)-2(R)-[1(S)-(Hydroxycarbamoyl)-4-phenyl-3-butenyl]-2′-isobutyl-2′-(methanesulfonyl)-4-methylvalerohydrazide; N-hydroxy-(5S,6S)-1-methyl-6-{[4-(2-methyl-4-quinolinylmethoxy)anilinyl]carbonyl}-5-piperidinecarboxamide; N-hydroxy-trans-{[4-(4-quinolinyloxymethyl)anilinyl]carbonyl}-1-cyclohexanecarboxamide; 4-[[4-(2-butynyloxy)phenyl]sulfonyl]-N-hydroxy-2,2-dimethyl-(3S)-thiomorpholinecarboxamide; trans-cyclohexanedicarboxylate derivatives; trans-cyclopentanedicarboxylate derivatives; piperazine-based hyroxyamic acids; β-aryl succinic acid hydoxamates; and azasugar-based hydroxamic acid derivatives. Since TACE is closely related to other naturally occurring enzymes, most of the known TACE inhibitors are non-specific. However, the present invention is intended to encompass both non-specific and specific inhibitors of TACE.

TACE is believed to be responsible for the cleavage of additional receptors on the platelet surface, such as P-selectin, CD40L, GPVI and GPV. Thus, TACE inhibition during platelet storage may be beneficial by also inhibiting the cleavage of these receptors which play an important role during hemostasis.

The inhibition of TACE may also be beneficial to patients who develop thrombocytopenia, e.g. patients with thrombocytopenia due to the existence of certain tumors, bacterial infections, or the side effects of drugs. This may be due to the observation that TACE-dependent platelet clearance may also occur in certain pathological complications.

Typical platelet survival curves seen when subjects are transfused with either fresh or several day old untreated platelet concentrates show reduced recovery of stored platelets almost immediately after transfusion, while the clearance rate of the remaining cells is not significantly different from fresh platelets. However, the inhibition of platelet-derived metalloproteinases or TACE during platelet storage according to the present invention markedly improves post-transfusion recovery of these cells and, surprisingly, blocks GPIbα shedding resulting in significantly improved cell function.

When platelets are incubated in the presence of the inhibitor during storage, the inhibitor can either be added to the storage container prior to addition of the platelets, for example, but not limited to, by coating the container with the inhibitor, or by sterile injection of the inhibitor into the container. Alternatively, the inhibitor can be added to the storage container after the platelets have already been collected therein, either prior to the start of or anytime during the storage procedure. Suitable storage containers for purposes of this invention include blood collection bags and platelet storage containers of the type used in blood banks and similar facilities.

The platelets incubated with the inhibitor can then be stored in a manner conventional in the art. Preferably, the inhibitor is present in the storage container with the platelets at a concentration of from about 0.5 ng/ml to about 10 mg/ml. More preferably, the inhibitor is present in the storage container with the platelets at a concentration of from about 5 ng/ml to about 1 mg/ml. Most preferably, the inhibitor is present in the storage container with the platelets at a concentration of from about 50 ng/ml to about 0.5 mg/ml.

As used herein, “container” means any vessel in which whole blood, megakaryocytes, platelets, platelet glycoprotein (GP) Ibα shedding inhibitors or metalloproteinase inhibitors may be kept for any period of time outside the body of the recipient or donor. This includes cell culture dishes and/or flasks; syringes; blood collection and/or separation bags, tubes, needles and/or apparatus; platelet storage bags, test tubes and tubing. This listing of containers is merely exemplary in nature, and is non-limiting in regard to the types of containers which may be used in the practice of the present invention.

It has previously been found that the survival of platelets in storage can be enhanced if the platelets are chilled. Chilling the platelets also facilitates their rapid clearance and deposition in the liver since apoptosis of the platelets is inhibited thereby. The platelets are stored at temperatures significantly reduced (“chilled”) from standard platelet storage temperatures, e.g. less than about 22° C., and preferably from about 0° C. to about 4° C., to reduce the metabolic activity of the platelets. Platelets stored at about 4° C. are metabolically less active and therefore do not generate large amounts of CO₂, as compared with platelets stored at, for example, 22° C. It is theorized that the dissolution of CO₂ in the platelet matrix may result in a reduction in pH and a concomitant reduction in platelet viability. Storing the platelets at reduced temperatures can diminish the amount of CO₂ generated during storage, and thereby permit the simplified design and construction of platelet storage containers.

The present invention also encompasses methods for treating platelets with an inhibitor, as defined herein, that modulates or inhibits the cleavage of platelet glycoprotein Ibα (GPIbα) from the platelets, or that inhibits the activity of TACE. The method comprises contacting the platelets with the inhibitor following transfusion from a donor. The platelets can be stored in a blood collection vessel for subsequent use in medical procedures.

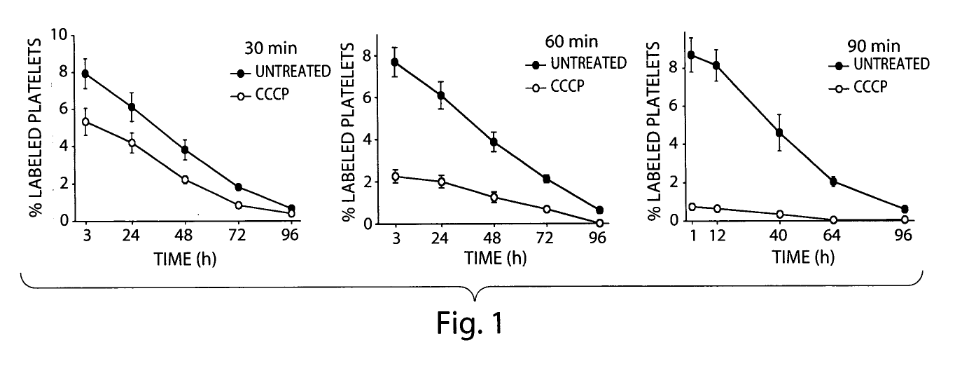

Turning now to the Figures, FIG. 1 represents a series of graphs showing that carbonyl cyanide m-chlorophenylhydrazone (CCCP) treatment decreases post-transfusional recovery of mouse platelets. As shown in FIG. 1, washed platelets are treated for 30 minutes, 60 minutes or 90 minutes with 100 μM CCCP, labeled with 1 μg/ml calcein (15 minutes at room temperature), and injected into mice. Blood is drawn at different time points after infusion and stained with JON1-PE (anti GPIIb/IIIa) for 10 minutes at room temperature. Platelets are identified by PE-fluorescence and forward scatter. Results in FIG. 1 are shown as % labeled platelets ±SE, n=5.

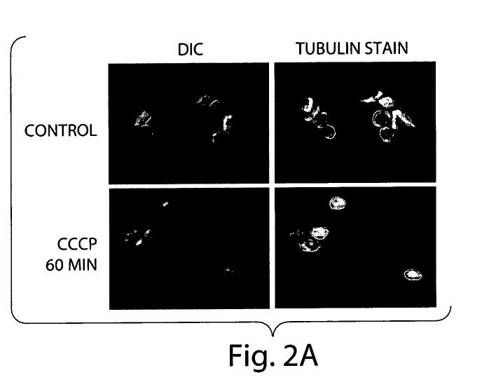

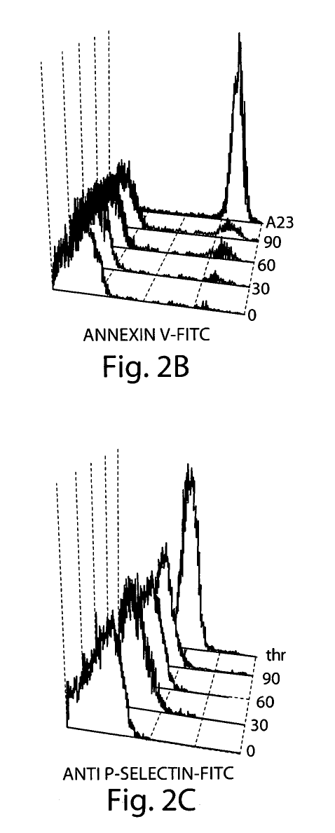

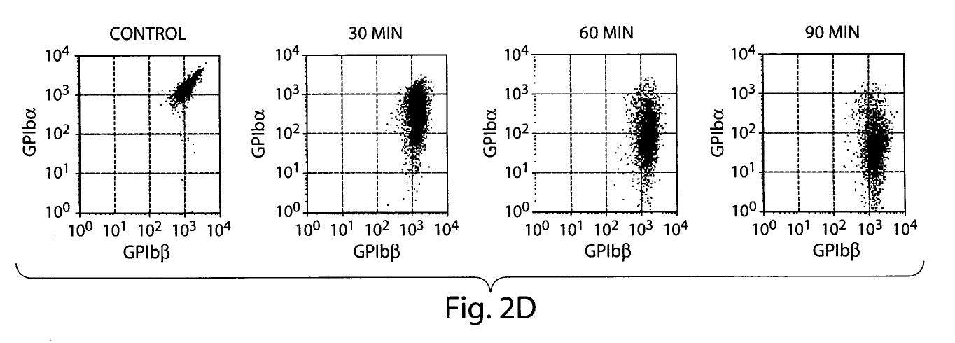

FIGS. 2A-2D are pictoral and graphical representations of the functional and morphological changes observed on CCCP-treated platelets resembling platelet storage lesion. FIG. 2A is a series of photomicrographs showing washed mouse platelets treated with 100 μM CCCP for 60 minutes. Samples are immediately fixed in 2% formaldehyde and permeabilized with 0.1% Triton X-100. Staining is performed with a mixture of mouse mAbs against mouse β-tubulin 1/2 and α-tubulin (Sigma), and an FITC-labeled goat anti-mouse secondary antibody. The left panel shows the differential interference contrast (DIC) images; the right panel shows immunofluorescent images. In FIG. 2B and FIG. 2C, platelets are stained for 15 minutes at room temperature with 2.5 μg/ml annexin V-FITC or RB40.34-FITC (anti-P-selectin), and immediately analyzed on a FACScalibur. 0=untreated platelets; 30, 60, 90=platelets treated with 100 μM CCCP for 30, 60 and 90 minutes, respectively; A23=platelets activated for 10 minutes with 50 μg/mL A23187; and thr=platelets activated for 10 minutes with 0.5 U/mL thrombin. FIG. D is a dual color analysis of control and CCCP-treated platelets stained for 15 minutes with 2.5 μg/mL p0p4-PE (anti GPIbα) and p0p1-FITC (anti GPIbβ). The results are representative of 5 individual experiments.

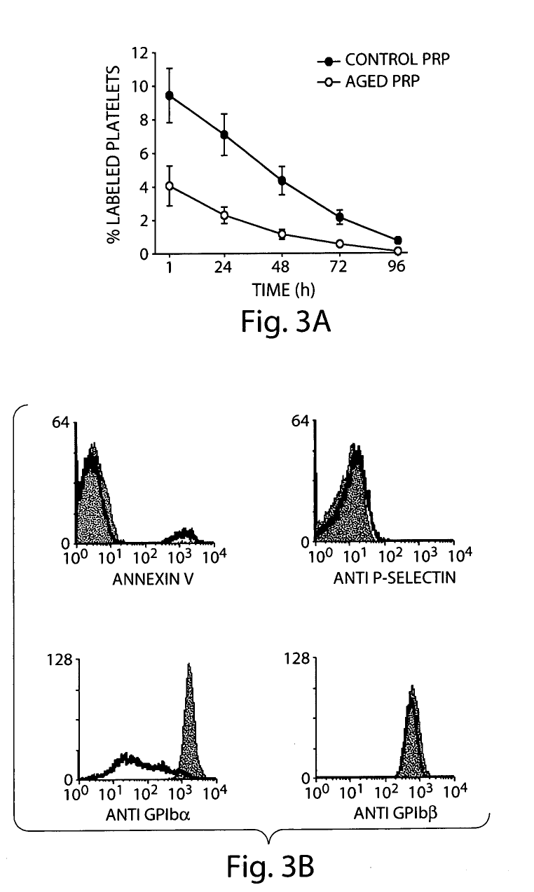

FIGS. 3A and 3B are graphs showing that the storage of mouse platelets induces clearance in vivo and profound shedding of GPIbα. In FIG. 3A, heparinized PRP (t=0 h and t=16 h) is washed twice and platelets are labeled with 1 μg/ml calcein for 10 minutes at room temperature. 2×10⁸ platelets are injected intravenously into mice, and blood is drawn from these mice at different time points after infusion. Blood platelets are stained with a PE-labeled mAb against GPIIb/IIIa for 10 minutes at room temperature, and samples are analyzed using flow cytometry. Results are shown as % labeled platelets ±SE, n=5. FIG. 3B shows the surface expression of P-selectin, phosphatidyl serine, GPIbα and GPIbβ as determined by flow cytometry on fresh PRP (shaded area), and PRP stored for 16 h at 37° C. (black curve). Results are representative of 5 individual experiments.

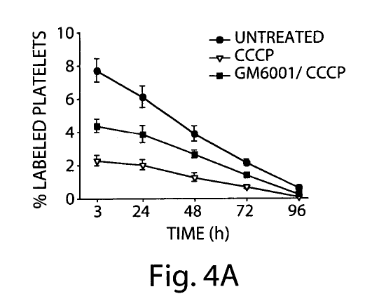

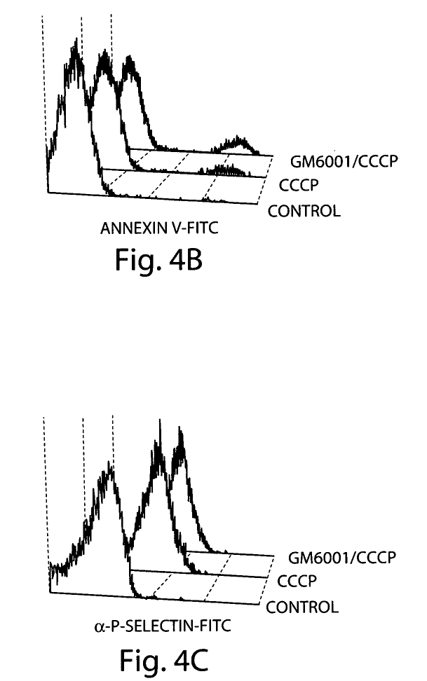

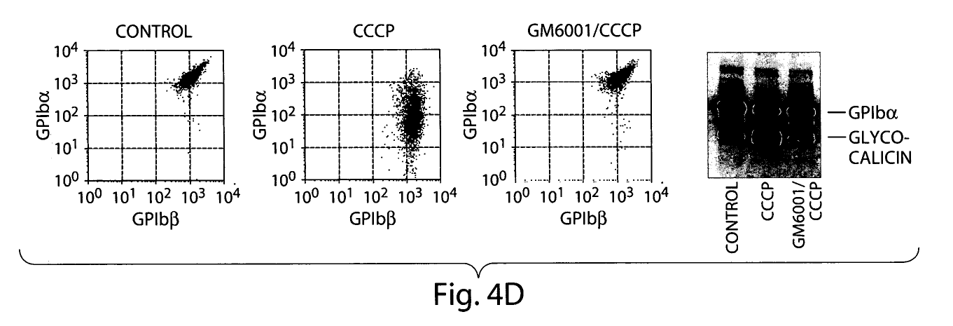

FIGS. 4A-4D show that the inhibition of metalloproteinase activity in CCCP-treated platelets improves the post-transfusion recovery, and inhibits the cleavage of GPIbα. In FIG. 4A, washed platelets are incubated for 60 minutes with 100 μM CCCP in the presence of 40 μg/ml GM6001, labeled with 1 μg/ml calcein (15 minutes at room temperature), and injected into mice. Blood is drawn at different time points after infusion and stained with JON1-PE (anti GPIIb/IIIa) for 10 minutes at room temperature. Platelets are identified by PE-fluorescence and forward scatter. Results are shown as % labeled platelets ±SE, n=5. In FIG. 4B and FIG. 4C, platelets are stained for 15 minutes at room temperature with 2.5 μg/ml annexinV-FITC or RB40.34-FITC (anti P-selectin), and immediately analyzed on a FACScalibur, control=untreated platelets; CCCP=platelets treated for 60 minutes with 100 μM CCCP; GM6001/CCCP=platelets treated for 60 minutes with 40 μg/ml and 100 μM GM6001. FIG. 4D is a dual color analysis of platelets incubated with CCCP±GM6001 and stained for 15 minutes with 2.5 μg/mL p0p4-PE (anti GPIbα) and p0p1-FITC (anti GPIbβ). Results are representative of 5 individual experiments.

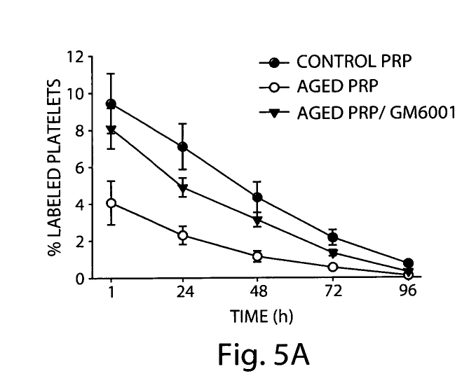

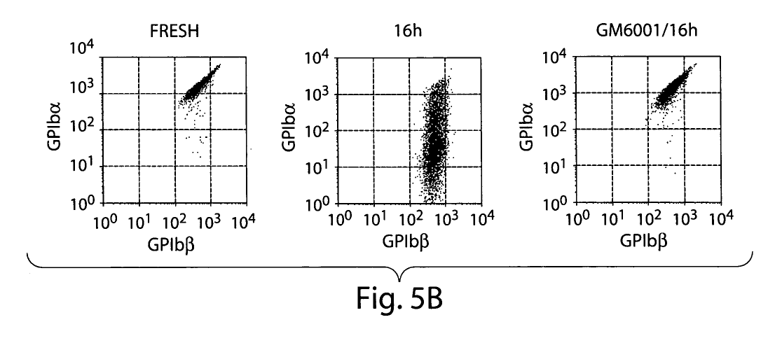

FIGS. 5A and 5B show that the inhibition of metalloproteinase activity in stored platelets improves post-transfusion recovery and inhibits cleavage of GPIbα. In FIG. 5A, heparinized PRP is incubated for 16 h at 37° C. in the presence or absence of GM6001. Platelets are washed twice and labeled with 1 μg/mL calcein for 10 minutes at room temperature. 2×10⁸ platelets are injected intravenously into mice, and blood is drawn from these mice at different time points after infusion. Blood platelets are stained with a PE-labeled mAb against GPIIb/IIIa for 10 minutes at room temperature, and samples are analyzed with flow cytometry. Results are shown as % labeled platelets±SE, n=5. FIG. 5B shows the surface expression of GPIbα as determined with flow cytometry on fresh PRP (shaded area), and PRP stored for 16 h at 37° C. in the presence (GM/16 h) or absence (16 h) of GM6001. Results are representative of 5 individual experiments.

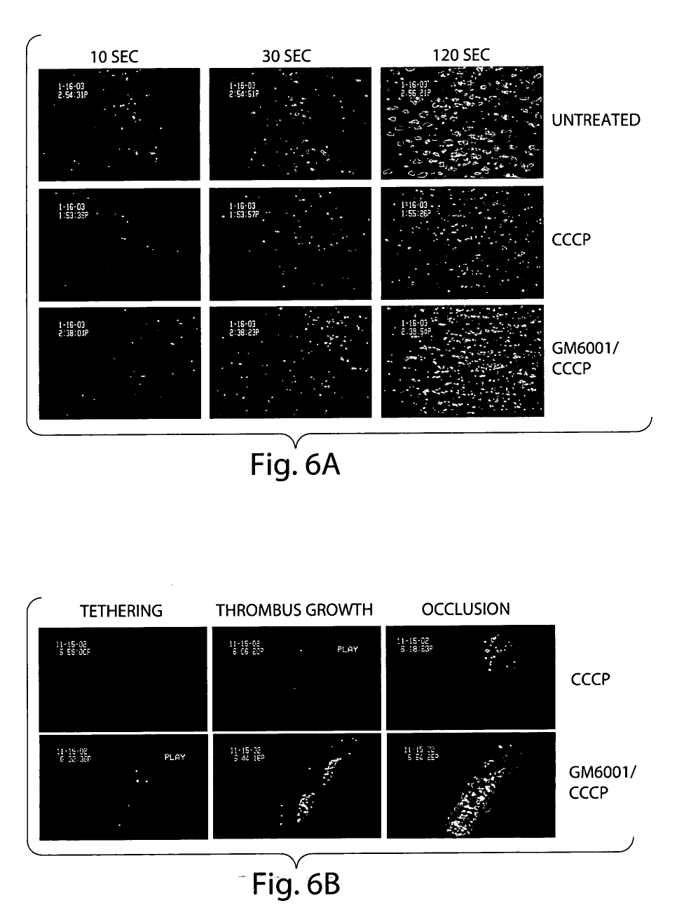

FIGS. 6A and 6B show that the inhibition of metalloproteinase activity improves the hemostatic function of injured mouse platelets. FIG. 6A represents the results of parallel-plate flow chamber studies. Washed platelets are incubated for 60 minutes with 40 μg/ml CCCP in the absence or presence of 40 μg/ml GM6001, labeled with 2.5 μg/ml calcein (15 minutes at room temperature), and added to platelet poor whole blood at a concentration of 5×10⁸ platelets/mL. Blood is perfused for 2 minutes over a collagen surface at a wall shear rate of 1000s⁻¹. Shown are representative images of a portion of the flow chamber taken at 10, 30 and 120 seconds of perfusion. FIG. 6B is an arterial thrombosis model. Mice are injected with fluorescently labeled platelets treated for 60 minutes with CCCP in the absence or presence of GM6001. Arterioles (60-100 μm in diameter) are selected and vascular injury is provoked by superfusion with ferric chloride.

The following examples are provided for the purposes of illustration and are not intended to limit the scope of the present invention.

### EXAMPLES

Materials and Methods used for the following Examples 1-6 are described below:

Animals:

C57BL/6 WT mice (Jackson Laboratory, Bar Harbor, Me.) were used for all experiments throughout the study. All animals were maintained and treated as approved to NIH standards as set forth in “The Guide for the Care and Use of Laboratory Animals”.

Reagents and Antibodies:

Lovenox (enoxaparin sodium; Aventis Pharmaceuticals Products), collagen reagent Horm (NYCOMED), bovine serum albumin (BSA; Chrono-log Corp.), carbonyl cyanide m-chlorophenylhydrazone (CCCP), prostacyclin (PGl₂), human thrombin, A23187, ferric chloride (FeCl₃; Sigma Pharmaceuticals), AnnexinV-FITC, calcein acetoxymethyl ester (Molecular Probes), and GM6001 (Calbiochem) were purchased. Rat anti-mouse CD62P antibody RB40.34-FITC was purchased from BD Pharmingen, all other antibodies were generated and modified: p0p1-anti mGPIbα, p0p4/5-anti mGPIbα, and JON1-anti mGPIIb/IIIa.

Platelet Preparation and Counting:

Mice were bled under isoflurane anesthesia (IsoFlo; Abbott Laboratories, North Chicago, Ill.) from the retro-orbital plexus into a tube containing 0.3 vol PBS containing 30 U/mL heparin. Platelet rich plasma (PRP) was obtained by centrifugation at 300×g for 10 minutes at room temperature. PRP was centrifuged at 1,000×g in the presence of PGl₂ for 7 minutes at room temperature. After one washing step, pelleted platelets were resuspended in modified Tyrode-HEPES buffer (137 mmol/L NaCl, 0.3 mmole/L Na₂HPO₄, 2mmol/L KCL, 12 mmol/L NaHCO₃, 5 mmol/L Hepes. 5 mmol/L glucose, 1 mmol/L CaCl₂, pH 7.3, containing 0.35% BSA). Platelet counts were determined in an improved Neubauer hemocytometer.

Mitcochondrial Damage and Storage:

Mitochondrial damage: Washed platelets resuspended in modified Tyrodes-Hepes buffer at a concentration of 1.5×10⁹ platelets/mL were treated for various times at 37° C. with 100 μm CCCP in the presence or absence of GM6001 (100 μM). Storage: Platelet rich plasma (PRP) was incubated for 16 h at 37° C. under agitation. After treatment, platelets were washed once and resuspended in modified Tyrodes-Hepes buffer at a concentration of 1.5×10⁹ platelets/mL.

1×10⁶ platelets were stained for 10 minutes with saturating amounts of flourophore-conjugated antibodies at room temperature and immediately analyzed on a FACS calibur. Flow cytometric analysis of annexinV binding to the indicated platelet preparation was measured according to the instructions of the manufacturer. Platelets were gated by FSC/SSC characteristics.

Platelet Recovery and Survival in Mice:

Platelets were labeled with 1 μg/mL calcein acetoxymethyl ester (calcein) for 15 minutes, washed once, and intravenously injected into mice (1.5×10⁸ platelets per 15 g body weight). For determination of the in vivo recovery and survival of transfused platelets, blood samples were collected from the retro-orbital plexus at various time points after transfusion using heparin coated microcapillaries. Diluted whole blood samples were stained with JON1-PE and analyzed by flow cytometry to determine the percentage of calcein-positive platelets.

Immunoblotting:

Washed platelets treated with CCCP in the presence or absence of GM6001 were lysed in 2×SDS sample buffer. After lysis, the whole-cell extract was run on an SDS-PAGE gel under non-reducing conditions and transferred to a PVDF membrane. The membrane was first incubated with 5 μg/mL p0p5 antibody followed by rabbit anti-rat-HRP (1 μg/mL). Proteins were visualized by enhanced chemiluminescence (ECL).

Flow Chamber Studies:

Washed platelets were treated with 40 μg/ml GM6001 for 30 minutes at 37° C., labeled with 2.5 μg/mL calcein, and washed once in modified Trodes-Hepes buffer. Platelet poor whole blood was reconstituted with 0.5×10⁹ labeled platelets/mL immediately before perfusion in a parallel-plate flow chamber system. Briefly, a silicone gasket with a flow path height of 127 μm was placed between a flat perfusion chamber (Glycotech, Rockville, Md.) and a 35 mm tissue culture dish (Corning) coated with 50 μg/mL collogen (Horm) for 1 hour at ambient temperature. Perfusion was carried out at a wall shear rate of 1,000 s⁻¹ for 2 minutes. Platelet adhesion was visualized with an Axiovert 135 inverted microscope (Zeiss) equipped with a 100W HBO fluorescent lamp source (Optiquip, Highland Mills, N.Y.) and a silicon intensified tube camera (C 2400; Hamamatsu, Middlesex, N.J.) connected to an S-VHS video recorded (AG-6730; Panasonic Matsushita Electric, Japan). Images were analyzed using NIH Image 1.61 software.

In vivo Thrombosis Model:

Male mice (3-4 weeks old) were injected intravenously with calcein acetoxymethyl ester-labeled platelets, anesthetized, and the mesentery was exposed through a midline abdominal incision. Vessels were monitored until cessation of blood flow lasted longer than 10 seconds (occlusive thrombi).

### Example 1

Mitochondrial Damage in vitro Reduces Post-transfusion Recovery of Platelets in Mice.

Isolated mouse platelets (1.5×10⁹/ml) were treated with 100 μM carbonyl cyanide m-chlorophenylhydrazone, a lipid-soluble amphipathic molecule that specifically uncouples oxidative phosphorylation in mitochondria, to study the role of mitochondria in platelet storage lesion. Platelet survival was tested upon transfusion into mice. Cyanide m-chlorophenylhydrazone treatment reduced post-transfusion recovery of mouse platelets by about 23%, 61% and 91% when the cells were incubated with the molecule for 30, 60 and 90 minutes, respectively. No significant differences were observed when the lifespan of untreated and cyanide m-chlorophenylhydrazone treated platelets that survived in circulation were compared.

### Example 2

Cyanide m-chlorophenylhydrazone Treated Platelets Show a Platelet Storage Lesion-like Phenotype.

The shape, membrane asymmetry and surface expression of various glycoproteins was studied for cyanide m-chlorophenylhydrazone treated platelets to investigate whether changes similar to those observed in platelet storage lesion were observed. As shown by Differential Interference Contrast (DIC) microscopy, the majority of control platelets were discoid in shape while platelets treated with cyanide m-chlorophenylhydrazone for 60 minutes seldom exhibited this phenotype. This change in shape was confirmed by fluorescence microscopy studies where we observed that cyanide m-chlorophenylhydrazone treatment altered the distribution of microtubules from marginal band to homogeneous patterns. Similar cytoskeletal rearrangements have been reported for spherical platelets due to cellular activation or inhibition of serine/threonine protein phosphatases type 1 and 2a.

Surface expression of phosphatidyl serine (PS) on dying cells is widely accepted as an “eat me” signal for scavenger receptor-bearing phagocytes. But although surface expression of PS has been detected on stored platelets, it is currently not clear whether or not this change in membrane asymmetry plays a role for the increased clearance of these cells upon transfusion. As shown in FIG. 2B, incubation of isolated platelets with cyanide m-chlorophenylhydrazone (CCCP) for 30, 60 and 90 minutes induced PS exposure, as measured by binding of annexinV-FITC on 2.4%, 5.2% and 10.0% of all platelets, respectively. As determined by their forward scatter signals (FSC), annexinV-positive platelets were smaller in size, indicating that they might have released microparticles into the supernatant.

P-selectin, a glycoprotein only detected on the surface of activated platelets, was shown to be expressed on human platelets after extended storage and initially showed some promise for predicting post-transfusion platelet recovery in humans. P-selectin expression on CCCP-treated platelets significantly increased over time, with expression levels after 90 minutes of treatment being about 25% of those observed on platelets activated with the strong agonist thrombin.

The most striking phenotype of CCCP-treated platelets was observed when dual color flow cytometry studies were performed to measure the surface expression of GPIbα and GPIbβ, two subunits of the GPIb-V-IX receptor complex. After treatment with CCCP for 30, 60 or 90 minutes, surface expression of GPIbα was reduced by 78.4%, 90.9% or 95.2%, respectively, when compared to untreated control platelets. In contrast, surface expression of GPIbα was not significantly reduced, suggesting that CCCP treatment induces proteolysis of GPIbα. The latter could be confirmed by western blot analysis where we detected a 130 kD fragment of GPIbα (also called glycocalicin) in the supernatant of CCCP-treated platelets.

Taken together, these studies demonstrate that specific damage of mitochondria induces a phenotype in mouse platelets that is comparable to what is known from studies on human platelets stored under blood banking conditions.

### Example 3

Platelet Storage Lesion in Mouse Platelets.

To further correlate CCCP-induced changes in platelet function and morphology to platelet storage lesion, mouse platelets stored in plasma (PRP) for an extended period of time were analyzed. Due to limitations in storage containers and therefore difficulties in stabilizing the pH, the optimal conditions for the preparation and storage of mouse PRP were found to be the following: heparin instead of ACD as an anticoagulant, storage at 37° C. instead of room temperature, and agitation. Post-transfusion recovery of platelets stored under such conditions for 16 hours was less than 50% compared to fresh PRP, the survival curves being similar to those observed for platelets treated with CCCP for 60 minutes. Stored platelets underwent shape change, partially expressed phosphatidyl serine, and significantly downregulated GPIbα but not GPIbβ from their surface. In contrast to CCCP-treated platelets, no significant increase in the surface expression of P-selectin was detectable.

### Example 4

Role of Metalloproteinases in Platelet Storage Lesion.

Metalloproteinases have been shown to play a role in apoptosis of different cell types. To find out whether metalloproteinases play a role in the present model of platelet storage lesion, isolated platelets were treated for 60 minutes with CCCP in the presence or absence of 100 μM GM6001, a broad range metalloproteinase inhibitor, and transfused into mice. Post-transfusion recovery of CCCP-treated platelets (60 minutes) was markedly improved when cells were co-incubated with GM6001. In vitro analysis showed no significant differences in shape change as well as surface platelet storage lesion and P-selectin expression for platelets treated for 60 minutes with CCCP in the presence or absence of GM6001, demonstrating that GM6001 does not inhibit CCCP action. As shown in flow cytometry and western blotting, however, proteolysis of GPIbα induced by CCCP was almost completely inhibited by GM6001 (7.4% vs. 90.0% in the absence of GM6001), suggesting that metalloproteinase activity is involved in the cleavage of the glycocalicin fragment of GPIbα.

### Example 5

Effect of Metalloproteinase Inhibition on Platelet Function.

Since GM6001 had such profound effects on post-transfusion recovery of CCCP-treated and stored platelets in mice, we next tested if the inhibitor itself interferes with platelet function in vitro. GM6001 did not affect platelet aggregation in response to collagen as well as high and low dose thrombin in aggregation. It also had no significant effect on platelet adhesion and thrombus formation on a collagen surface under arterial flow conditions.

Thrombus formation of injured platelets in vitro under suitable conditions was studied. Equal numbers of platelets in untreated, CCCP-treated and GM6001/CCCP-treated samples were studied. Adhesion and thrombus formation of CCCP-treated platelets was almost completely inhibited under such conditions. In contrast, platelets injured in the presence of GM6001 showed almost normal adhesion to collagen as only a slight decrease in the surface area covered within 2 minutes of perfusion was observed. These data are in line with the current model for thrombus formation, which shows a key role for the interaction of platelet GPIbα with its major ligand von Willebrand factor in enabling platelet adhesion to a prothrombotic surface.

Intravital microscopy studies in a model of arterial thrombosis were performed to show that platelets injured in the presence of GM6001 are functional in vivo. In this model, we inject calcein-labeled platelets into mice and monitor their adhesion to the injured vessel wall as well as their incorporation into a growing thrombus. GM6001 not only markedly improves the survival of CCCP-treated cells in mice, but also increases the adhesiveness of the remaining circulating cells towards the damaged vasculature. In contrast to platelets treated with CCCP in the absence of metalloproteinase inhibitor, GM6001/CCCP-treated platelets actively adhered to damaged endothelium and early thrombi, resulting in a brightly stained occulsive thrombus.

### Example 6

Testing of Stored Platelets for Platelet Storage Lesion

Platelets are obtained and separated from the peripheral whole blood of a patient. The platelets are stored at 20-24° C. under constant agitation in anti-coagulant-treated donor serum in a collapsible container standard in the art. GM6001 is sterilely added through an injection port in the container. Platelets are allowed to incubate in the presence of the GM6001 for up to the maximum time of 6 days recommended for platelet storage. Platelets are prepared for transfusion in the usual manner and transfused into the patient.

To monitor the effect of GM6001 on GPIbα release during storage, a platelet concentrate from a single donor is divided into two equal portions and stored in two collapsible platelet bags. GM6001 is added to one bag, and a control is added to the other bag. Samples of platelets are taken every day of the following 5 days. The platelets are separated from the supernatant by centrifugation at 2000 rpm for 10 minutes. The supernatants are centrifuged again at 15,000 rpm for 10 minutes in a desktop centrifuge to yield the plasma samples. The platelet pellets are dissolved in a lysis buffer. The GPIbα levels in the supernatant are measured. The GPIbα levels in the control are found to be considerably higher than the GPIbα levels in the GM6001 sample.

The purpose of the following Examples 7-9 is to investigate whether or not TACE is involved in the shedding of GPIbα. TACE^{ΔZnΔZn} chimeric mice, which lack the TACE enzyme in all cells of the hematopoietic system, were generated. The results described below demonstrate that TACE mediates shedding of GPIbα in mouse platelets in vitro and in vivo.

Materials and Methods

Animals:

TACE^{ΔZnΔZn} chimeric mice (Amgen, Seattle, Wash.), C57B1/6, were used for all experiments throughout the study. Homozygous TACE^{ΔZnΔZn} null mice were produced by cross-breeding TACE heterozygous mice. Fetal liver cells were isolated at day 16.5 of embryonic development, and injected into irradiated C57B1/6 recipient mice (1250 rad, 1×10⁷ cells per mouse). The mice were genotyped by PCR analysis using DNA from blood samples. TACE activity in isolated blood leukocytes was determined by measuring the surface expression of L-selectin in response to phorbol 12-myristate 13-acetate (PMA) activation (200 ng/ml, 10 min.).

Reagents and Antibodies:

Lovenox (enoxaparin sodium; Aventis Pharmaceuticals Products), collagen reagent Horm (NYCOMED), bovine serum albumin (BSA; Chrono-log Corp.), carbonyl cyanide m-chlorophenylhydrazone (CCCP), prostacyclin (PGl₂), human thrombin, A23187, ferric chloride (FeCL₃; Sigma Pharmaceuticals), AnnexinV-FITC, calcein acetoxymethyl ester (Molecular Probes), and PMA were purchased.

Platelet Preparation and Counting:

Mice were bled under isoflurane anesthesia (IsoFlo; Abbott Laboratories, North Chicago, Ill.) from the retro-orbital plexus into a tube containing 0.3 vol PBS containing 30 U/mL heparin. Platelet rich plasma (PRP) was obtained by centrifugation at 300×g for 10 minutes at room temperature. PRP was centrifuged at 1,000×g in the presence of PGl₂ for 7 minutes at room temperature. After one washing step, pelleted platelets were resuspended in modified Tyrode-HEPES buffer (137 mmol/L NaCl, 0.3 mmole/L Na₂HPO₄, 2 mmol/L KCL, 12 mmol/L NaHCO₃, 5 mmol/L Hepes. 5 mmol/L glucose, 1 mmol/L CaCl₂, pH 7.3, containing 0.35% BSA). Platelet counts were determined in an improved Neubauer hemocytometer.

GPIbα shedding from mouse platelets:

Washed platelets resuspended in modified Tyrodes-Hepes buffer at a concentration of 1.5×10⁹ platelets/mL were treated for various times at 37° C. with 100 μM CCCP, or for 10 minutes with 200 ng/ml PMA.

1×10⁶ platelets were stained for 10 minutes with saturating amounts of flourophore-conjugated antibodies at room temperature and immediately analyzed on a FACS calibur. Platelets were gated by FSC/SSC characteristics.

Platelet Recovery and Survival in Mice:

Platelets were labeled with 1 μg/mL calcein acetoxymethyl ester (calcein) for 15 minutes, washed once, and intravenously injected into mice (1.5×10⁸ platelets per 15 g body weight). For determination of the in vivo recovery and survival of transfused platelets, blood samples were collected from the retro-orbital plexus at various time points after transfusion using heparin coated microcapillaries. Diluted whole blood samples were stained with JON1-PE and analyzed by flow cytometry to determine the percentage of calcein-positive platelets.

Immunoblotting:

Soluble GPIbα (glycocalicin) was detected in the supernatant of DMSO-/CCCP-treated platelets as well as in plasma samples obtained from TACE +/+ and TACE −/− mice. Briefly, samples were diluted in 2×SDS sample buffer, analyzed on a SDS-PAGE gel under non-reducing conditions, and transferred to a PVDF membrane. The membrane was first incubated with 5 μg/ml p0p5 antibody followed by rabbit anti-rat-HRP (1 μg/ml). Proteins were visualized by enhanced chemiluminescence (ECL).

### Example 7

Surface Expression of GPIbα as Determined by Flow Cytometry.

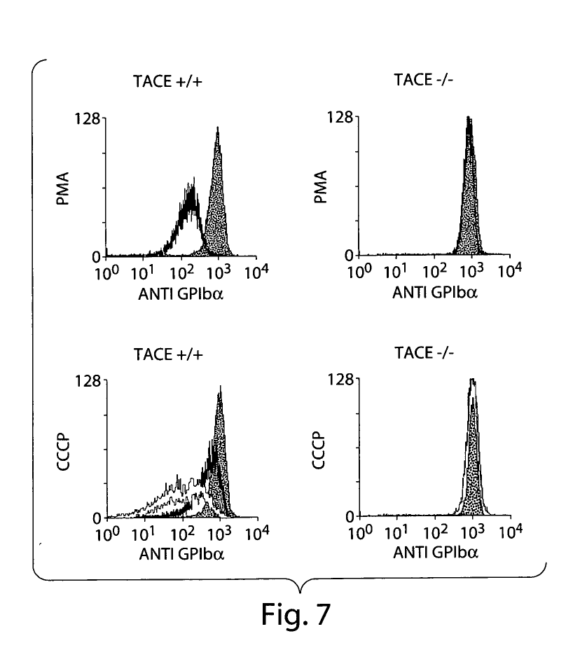

As shown in FIG. 7, washed platelets were treated with 200 ng/ml PMA for 10 minutes; 100 μM CCCP (cyanide m-chlorophenylhydrazone) for 30 minutes and 60 minutes; and stained with p0p4-PE (an anti-GPIbα antibody) for 10 minutes at room temperature. The platelets were immediately analyzed following treatment. The shaded area under the curve represents p0p4 staining of untreated platelets. The results are as shown.

### Example 8

Detection of Glycocalicin in the Supernatant of CCCP-treated Cells.

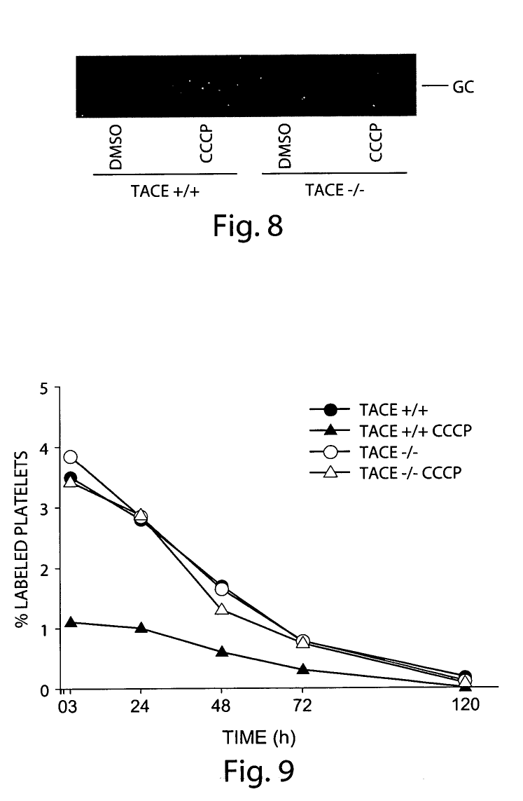

As shown in FIG. 8, washed platelets were treated for 60 minutes with 100 μM CCCP, and the supernatant was obtained by two centrifugation steps: the first being for 5 minutes at 5000 rpm, and the second being for 10 minutes at 15,000 rpm. Detection of glycocalicin was performed as described in the Materials and Methods section. The results are as shown.

### Example 9

Platelet Recovery and Survival in Mice

As shown in FIG. 9, washed platelets (TACE +/+ and TACE −/−) were treated with CCCP for 60 minutes, labeled with calcein, and injected into mice. For the determination of the in vivo recovery and survival of transfused platelets, blood samples were collected from the retro-orbital plexus at various time points after transfusion. The results are as shown in FIG. 9.

While this invention has been particularly shown and described with reference to preferred embodiments thereof, it will be understood by those skilled in the art that various changes in form and details may be made therein without departing from the spirit and scope of the invention as defined by the appended claims.

1. An improved blood product suitable for use in transfusions after storage comprising platelets which have been treated with an inhibitor effective to prevent the cleavage of GPIbα from the platelets.

2. The blood product of claim 1 wherein the inhibitor is a metalloproteinase inhibitor.

3. The blood product of claim 1 wherein the inhibitor is a TACE inhibitor.

4. The blood product of claim 1 which has been stored for a time period of from about 3 to 10 days at reduced temperatures.

5. The blood product of claim 4 which is stored for about 5 days at reduced temperatures.

6. The blood product of claim 1 wherein platelet recovery is enhanced and the platelet hemostatic function is preserved.

7. The blood product of claim 1 which also contains a platelet preserving agent an. agent that blocks platelet aggregation.

8. The blood product of claim 7 wherein the platelet preserving agent is an antibiotic.

9. The blood product of claim 1 which is also irradiated.

10. A method for treating a patient by transfusing the patient with the blood product of claim 1.

11. A container comprising the improved blood product of claim 1.

12. The container of claim 11 which is a blood collection bag.

13. The container of claim 11 which is a platelet storage container.

14. A method for storing a blood product in a storage facility comprising
combining, in a suitable container, a blood product and a metalloproteinase inhibitor or a TACE inhibitor;
storing the container for a period of from about 3 to 10 days; and
using the blood product from the container in a blood transfusion.

15. The method of claim 14 wherein the container is stored for a period of about 5 days.

16. The method of claim 14 wherein the subject is a human.

17. The method of claim 14 wherein the blood product is further treated to preserve platelet function.

18. The method of claim 17 wherein the treatment is selected from the group consisting of antibiotics, irradiation, and chemical inactivation agents.

19. A method for evaluating the quality of stored platelets prior to infusion into a patient comprising the steps of
combining, in a suitable container, a blood product and a metalloproteinase inhibitor or a TACE inhibitor;
taking a sample from the container, and
measuring the level of GPIbα in the supernatant, where a relatively low level of GPIbα indicates that the quality of stored platelets has been preserved.

20. A method for treating thrombocytopenia in a subject comprising administering to said subject a pharmaceutical preparation containing, as an active ingredient, a TACE inhibitor.

21. The method of claim 20 wherein the thrombocytopenia is due a condition selected from the group consisting of a tumor in the subject, a bacterial infection in the subject, or the side effect of a prior drug treatment regime on the subject.

22. The method of claim 20 wherein the subject is a human patient.
